(19) United States
(12) Patent Application Publication
(10) Pub. No.: US 2012/0233456 A1
(43) Pub. Date: Sep. 13, 2012

(54) METHOD FOR SECURELY INTERACTING WITH A SECURITY ELEMENT

(76) Inventors: Stephan Spitz, Karlsfeld (DE); Lutz Hammerschmid, Munchen (DE)

(21) Appl. No.: 13/508,673

(22) PCT Filed: Oct. 26, 2010
(86) PCT No.: PCT/EP2010/006536

§ 371 Date: May 8, 2012

(30) Foreign Application Priority Data
Nov. 9, 2009 (DE) 102009052389.8

(51) Int. Cl. H04L 9/00

(52) U.S. Cl. 713/155

(57) ABSTRACT

A method for secured interaction with a security module which is integrated into an end device, via an input device of the end device, the input device being reserved by a security application which is executable in a trustworthy region of the end device. Subsequently, first authentication data are input via the reserved input device. The security application derives from the first authentication data by a secret data stored in the trustworthy region second authentication data. The latter are subsequently encrypted by the security application and transferred to the security module and/or to a server. In the security module and/or the server the received, encrypted second authentication data are finally decrypted.

The present invention relates to a method for secured interaction with a security module integrated in an end device, in particular the secure input of authentication data to the security module via an input device of the end device.

Many different applications, for example for paying for goods or services, can be made available to a user on a security module, for example in the form of a (U)SIM mobile radio card, a secure memory card or the like. Such an application itself as well as the data processed by the application are protected against unauthorized access on the security module. Before the application is released, for example in order to effect a payment transaction, it is necessary that the user authenticates himself to the security module, for example by means of a PIN. This makes it possible to prevent third parties from abusing the application for their purposes on the end device without the user's knowledge or consent, for example by means of malicious code.

The input of such authentication data, for example of a PIN, is normally effected via an input device of the end device, for example a keyboard, whereby the security module is integrated into the end device, preferably in removable fashion. Upon the input of the PIN and the transfer of the same to the security module it must be ensured that the PIN cannot be spied out by unauthorized third parties. This can be effected within a restricted framework by means of a secured input device. However, this cannot rule out that a malicious code application might abuse the secure input device for its purposes.

Further, it is desirable that any authentication data nevertheless spied out cannot be employed further by unauthorized third parties.

Therefore, it is the object of the present invention to make possible a secured interaction with a security module in an end device via an input device of the end device.

This object is achieved by a method, an end device and a system having the features of the independent claims. Advantageous embodiments and developments are stated in the dependent claims.

A method according to the invention for secured interaction with a security module which is integrated into an end device, via an input device of the end device, comprises the following steps. The input device of the end device is reserved by a security application which is executable in a trustworthy region of the end device. Subsequently, first authentication data are input via the reserved input device. The security application then derives second authentication data from the first authentication data by means of secret data stored in the trustworthy region. The second authentication data are subsequently encrypted by the security application and transferred in the encrypted state to the security module and/or to a server. In the security module and/or the server the received, encrypted second authentication data are finally decrypted.

An end device according to the invention which is adapted for integrating a security module comprises an input device as well as a trustworthy region with a security application executable therein. The latter is adapted to reserve the input device and to receive first authentication data via the reserved input device. The security application is further adapted to derive second authentication data from the first authentication data by means of secret data stored in the trustworthy region, to encrypt the second authentication data and to transfer them in encrypted form to a security module integrated into the end device and/or to a server.

Thus, it can be ensured that authentication data input via the input device are received and processed exclusively by the security application in the trustworthy region of the end device. The reserving of the input device blocks all other applications on the end device to the effect that they cannot utilize the input device while it is reserved by the security application. It is likewise rendered impossible through the security application that, while the input device is reserved, data camouflaged as putative input data, which have not been input via the input device, are smuggled into the trustworthy region for example by means of malicious code. The possibility of spying out authentication data on the way from the input device to the trustworthy region of the end device—by means of malicious code smuggled into an untrustworthy region of the end device—is thus effectively prevented.

If an attacker succeeds in spying the first authentication data by other means, however, for example by observing a user inputting the same or by tampering with the input device on the hardware level, the first authentication data obtained in this way are worthless to the attacker. Without knowledge of the secret data which are securely stored in the trustworthy region of the end device the attacker is unable to derive the second authentication data. These, and not the first authentication data, however, are necessary for a successful authentication to the security module and/or the server. This concept, by which only the second authentication data give the right to authenticate to the security module and/or the server, effectively prevents so-called phishing attacks. Even if the user transfers the first authentication data to an untrustworthy application by mistake, they cannot be employed by the attacker for the described reasons.

Since the second authentication data are encrypted before they are transferred to the security module and/or the server from the trustworthy region of the end device by the security application—and must thereby normally pass through the untrustworthy region of the end device—there can again not be any spying out, this time of the second authentication data, through malicious code installed in the untrustworthy region. The second authentication data required for authentication to the security module and/or the server are received in encrypted form by the security module and/or the server and subsequently decrypted in the security module and/or the server.

Thus, there is made possible a secured interaction with a security module in an end device via an input device of the end device or with a server. The method of the invention is advantageous not only in its high security but also in that the employed apparatuses, in particular the end device and the security module and/or server, as well as the communication between the end device and the security module and/or server can be maintained substantially unchanged. Only the security application which is executed in the trustworthy region of the end device is adjusted according to the invention. This means that an authorized user of a corresponding card is not notified of the PIN with which the card is personalized. Alternatively, the authorized user could be asked before the first use to input a PIN himself, which is written on the card for example by means of a Change PIN command. The trustworthy region of the end device is made available by a known hardware architecture, for example according to the ARM technology, a so-called ARM trust zone, as well as a security runtime environment executed therein which is complemented by the security application. Alternatively, known and suitable hardware architectures are for example virtualization technologies or Trusted Computing with TPM. An encrypted communication between the security application in the trustworthy region of the end device and the security module and/or server can be implemented by means of known technologies. In this way the method of the invention can be integrated into existing systems in a simple manner.

The security application reserves the input device of the end device preferably by the security application controlling a driver application, which is executable in the trustworthy region of the end device and which is provided for handling the data communication with the input device, such that all data input via the input device reach exclusively the trustworthy region of the data carrier. It is thus ensured that input data in the form of the first authentication data cannot be spied out by malicious code that might be installed in the untrustworthy region of the end device. Further, a reserving of the input device by the security application prevents another application from making use of the input device at the same time. In this way there is created a secured communication channel from the input device to the trustworthy region of the end device. The reserving of the input device by the security application further has the result that while the input device is reserved, no data from the untrustworthy region reach the trustworthy region of the end device—with the exception of the data input via the input device. The security application thus monitors that all data not input via the input device are discarded before they reach the trustworthy region of the end device. This prevents malicious code from smuggling putative input data into the trustworthy region, in particular past the driver application.

The secret data stored in the trustworthy region are preferably configured in end-device-specific fashion. The secret data can, in so doing, be incorporated into the end device during a personalization phase of the end device, being coordinated with the security module to be integrated into the end device and its user. In this way it is possible to prevent a third party, if he comes into possession of the security module and obtains knowledge of the first authentication data, from being able to authenticate himself to the security module by means of a further end device. This means that only a system comprising end device, security module and secret data coordinated therewith in the trustworthy region of the end device permits—if the first authentication data are known—a successful authenticating to the security module.

The second authentication data can be derived from the first authentication data by the security application encrypting the first authentication data into the second authentication data by means of the secret data as a secret key, for example by means of a cryptographic hash function or the like.

A transport key for encrypting the second authentication data for transferring the same in encrypted form to the security module and/or the server can be negotiated between the security application and the security module and/or the server in the known way, for example by the Diffie-Hellman key exchange method. However, it is also possible that one or several corresponding transport keys are already stored in the security module and/or the server and the trustworthy region of the end device.

The second authentication data serve, according to a preferred embodiment of the method of the invention, for releasing an application executable on the security module and/or the server, for example a payment application or the like.

As an end device there is preferably employed a mobile end device, in particular a mobile radio end device, a PDA, a smartphone, a netbook or the like. Suitable security modules are in particular (U)SIM mobile radio cards, secure memory cards or similar portable data carriers which can be integrated into a corresponding end device preferably in removable fashion. Suitable servers are in particular secured computers which are used for example at banks for financial transactions, e.g. for paying invoices, such as for example in so-called online banking.

The present invention will hereinafter be described by way of example with reference to the attached drawings. Therein are shown:

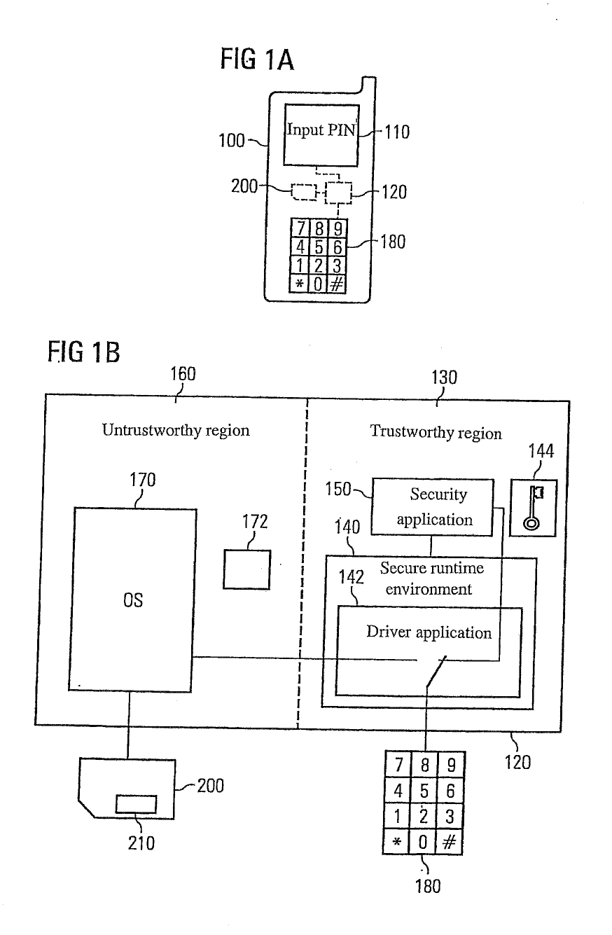

FIG. 1A schematically a preferred embodiment of an end device according to the invention;

FIG. 1B parts of the end device from FIG. 1A that are relevant to the invention in a likewise schematized representation; and

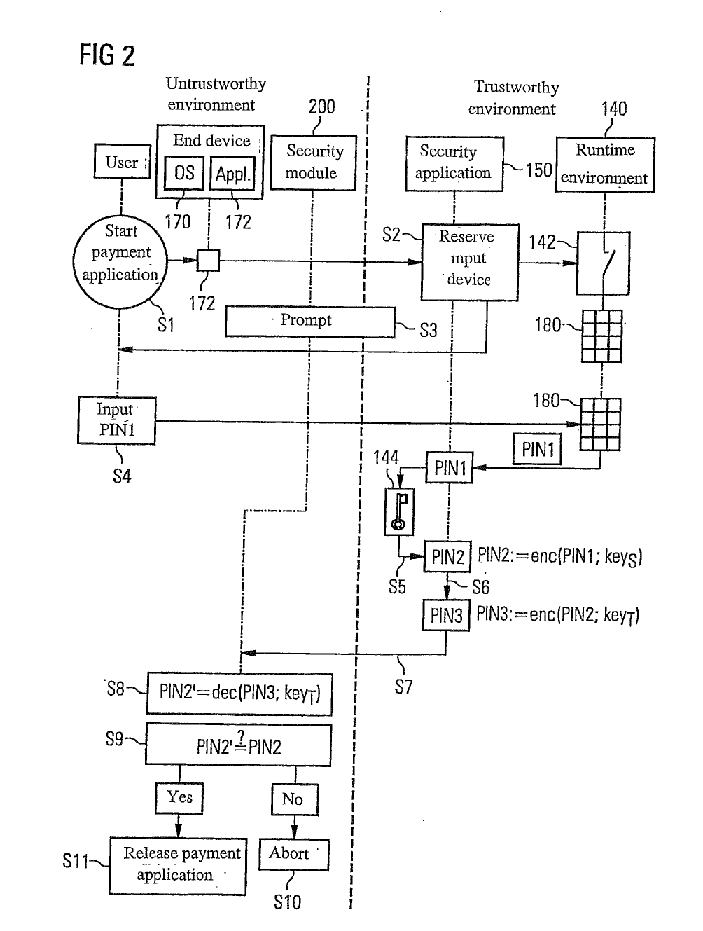

FIG. 2 steps of a preferred embodiment of a method according to the invention.

FIG. 1A shows an end device 100 in the form of a mobile radio end device. Other, in particular mobile, end devices are likewise possible, for example PDAs, smartphones, netbooks or the like.

The end device 100 comprises an output device 110 in the form of a display and an input device 180 in the form of a keyboard. Represented only sketchily, the end device 100 comprises a chip set 120 by means of which the end device 100 is controlled and which will be described more precisely with reference to FIG. 1B. The end device 100 is adapted to receive in removable fashion a security module 200, in the shown example a (U)SIM mobile radio card. Security modules of a different type and design are likewise possible, for example, a secure memory card. The security module 200 can make available to a user of the end device 100 various applications, for example a payment application 210 (cf. FIG. 1B). To keep unauthorized third parties from abusing such an application for their purposes, for example by means of malicious code installed on the end device 100, there are provided different security measures which will be described in detail hereinafter with reference to FIGS. 1B and 2.

The hardware 120 on which the control unit of the end device 100 is based makes available a trustworthy region 130 as well as an untrustworthy region 160. Security-relevant applications and data can in this way already be separated from less security-relevant data and applications at the level of the hardware. A hardware architecture from the company ARM provides such a setup for example under the name “Trust Zone”. At the level of the software, a secure runtime environment 140 controls the operations in the trustworthy region 130. A driver application 142 which processes all inputs on the input device 180 of the end device is part of the secure runtime environment 140. Thus, it can be ensured that, if necessary, data input via the input device 180 cannot reach the untrustworthy region 160 of the end device 100. However, the driver application 142 can also be set such that applications that are executed in the untrustworthy region 160 of the end device 100 also have access to the input device 180. A security application 150 which complements the secure runtime environment and which possesses direct access to and control over the driver application 142 will be described more precisely hereinafter with reference to FIG. 2, as will be a secret datum 144 in the form of a secret key key_{S} stored in the trustworthy region 130 (cf. FIG. 2).

As further represented in FIG. 1B, a usual operating system (OS) 170 controls the untrustworthy region 160 of the end device 100. Different non-security-relevant applications 172 can be executable therein. Likewise via the untrustworthy region 160 the security module 200 is connected to the end device 100. That is to say, while the security module 200 guarantees a sufficient security for applications 210 executable thereon as well as data processed by these applications 210, an interaction with the security module 200 which is normally carried out via the input device 180 of the end device 100 must be secured by means of further measures. This is necessary, because transferred data must always pass through the untrustworthy region 160 of the end device 100 and are hence possibly subject to attacks which are caused by malicious code which has been installed—usually unnoticed by the user—in the untrustworthy region 160.

With reference to FIG. 2, a method will hereinafter be represented that makes it possible to transfer authentication data to the security module 200 in secured fashion via the input device 180 of the end device 100 to thereby release for example a payment application 210 which is executable on the security module 200.

In a first step S1, the user of the end device 100 initiates, for example by means of an application 172 executed in the untrustworthy region 160 of the end device 100, the calling up of the payment application 210 on the security module 200.

Such a calling up causes the security application 150 which is executed in the trustworthy region 130 of the end device 100 to reserve the input device 180 in step S2. For this purpose, the security application 150 controls the driver application 142 in such a way that, while the input device 180 is reserved, all data input via the input device reach exclusively the trustworthy region 130 of the end device 100. Further, a reserving of the input device has the result that—except for the data input via the input device 180—no further data, in particular no data from the untrustworthy region 160, can reach the trustworthy region 130. In this way one can for example prevent any malicious code possibly located in the non-trustworthy region 160 from simulating an input device.

The security application 150 sends in step S3, when the input device 180 is reserved, a prompt which can be displayed to the user for example on the display 110 (cf. FIG. 1A).

There follows in step S4 the input of first authentication data PIN 1 by the user of the end device 100 via the reserved input device 180 which is controlled completely by the security application 150 by means of the driver application 142. The input first authentication data PIN 1 in this way reach the trustworthy region 130 of the end device 100 in secured fashion.

There, second authentication data PIN 2 are derived in step S5 by the security application 150 from the first authentication data PIN 1 by means of secret data 144 in the form of a secret key key_{S} stored in the trustworthy region 130. This can be effected for example by the second authentication data PIN 2 being formed from the first authentication data PIN 1 and the secret key key_{S} by means of a cryptographic hash function. It is also possible that only a specified number of digits of the calculated hash value is employed, for example in dependence on specifications of the security module 200. The secret key key_{S} is configured in end-device-specific fashion, adjusted to the corresponding application 210 on the security module 200 that is to be released by the authentication data PIN 2 derived by means of the key key_{S}. The PIN 2 is for example a PIN in the so-called EMV-PIN format 24xxxxffffffffff. The number 2 at the beginning establishes the format. The number 4 establishes the PIN length. The PIN itself, which is represented by xxxx, is converted with ff to 8 bytes. This means that after the PIN 1 has been encrypted, the resulting PIN 2 must be converted to an EMV-PIN. The security application 150 is solely authorized to access the secret datum 144, i.e. the secret key key_{S}.

Only the second authentication data PIN 2 derived in this way make possible a successful authenticating to the security module 200, not already the first authentication data PIN 1. Should an attacker thus succeed in spying the first authentication data PIN 1 in some way, he cannot utilize them for the described reasons, because it is not possible for him to derive the second authentication data PIN 2. This is only possible by means of the secret key key_{S} which, however, is stored—inaccessibly to the attacker—in the trustworthy region 130 of the end device 100.

To transfer the derived second authentication data PIN 2 in secured fashion from the trustworthy region 130 of the end device 100 to the security module 200, whereby the transferred data must pass through the untrustworthy region 160 of the end device 100, the second authentication data PIN 2 are encrypted once more by the security application 150 in step S6. For this purpose there is used a transport key key_{T}. The latter can be negotiated in the known way between the security application 150 and the security module 200. However, it is also possible that the transport key key_{T} has been already stored in the trustworthy region 130 of the end device 100 and in the security module 200, for example within the framework of corresponding personalization phases. Further, it is possible to employ an asymmetric encryption system for encrypting the second authentication data PIN 2, whereby encryption and decryption are effected in the known way by means of different keys, a public key and a secret key.

The encrypted second authentication data PIN 3 obtained in this way are now transferred to the security module 200 in secured—since encrypted—fashion in step S7.

The encrypted second authentication data PIN 3 received in the security module 200 are decrypted there in step S8, again by means of the transport key key_{T}. The thus obtained data PIN 2′ are compared in the security module 200 with the expected authentication data PIN 2 in step S9. If the comparison turns out positive, the user is considered positively authenticated and the payment application 210 is released in step S11. If the comparison yields that the decrypted data PIN 2′ do not match the expected second authentication data PIN 2, however, the attempt to release the payment application 210 is terminated by the security module 200 in step S10. Termination can mean here that in the case of a credit card, for example, the card answers a VERIFY command with an error code and a retry counter is decremented.

The method of the invention is not only able to authenticate a payment function, however, but rather it is also possible to authenticate a user in order to change PIN1 and PIN2 by a corresponding application of the method.

1.-12. (canceled)

13. A method for secured interaction with a security module integrated in an end device, via an input device of the end device, comprising the steps of:
reserving the input device by a security application executable in a trustworthy region of the end device;
inputting first authentication data via the reserved input device;
deriving second authentication data from the first authentication data by the security application by means of secret data stored in the trustworthy region;
encrypting the second authentication data by the security application and transferring the encrypted second authentication data to at least one of the security module and a server; and
decrypting the encrypted second authentication data in at least one of the security module and the server.

14. The method according to claim 13, wherein the input device is reserved by the security application controlling a driver application of the input device, which is executable in the trustworthy region, such that all data input via the input device reach exclusively the trustworthy region of the end device.

15. The method according to claim 13, wherein the security application monitors that, while the input device is reserved, all data not input via the input device are discarded before they reach the trustworthy region of the end device.

16. The method according to claim 13, wherein the secret data stored in the trustworthy region are configured in end-device-specific fashion.

17. The method according to claim 13, wherein the security application derives the second authentication data by encrypting the first authentication data into the second authentication data the secret data as a secret key.

18. The method according to claim 13, wherein a transport key that encrypts the second authentication data to transfer the encrypted second authentication data is negotiated between the security application and the security module and/or the server.

19. The method according to claim 13, wherein as an end device there is employed a mobile end device.

20. The method according to claim 13, wherein as a security module there is integrated into the end device a portable data carrier.

21. The method according to claim 13, wherein the second authentication data serve to release an application executable on the security module and/or the server.

22. An end device, adapted for integrating a security module, comprising:
an input device and a trustworthy region with a security application executable therein which is arranged to reserve the input device, to receive first authentication data via the reserved input device, to derive second authentication data from the first authentication data by secret data stored in the trustworthy region, to encrypt the second authentication data and to transfer them in encrypted form to a security module integrated into at least one of the end device and a server.

23. The end device according to claim 22, wherein the security application is arranged to execute via a processor the method recited in claim 13.

24. A system, comprising the end device as recited in claim 22 and as a security module integrable into the end device, which executes via a processor, the method recited in claim 13.
